(19) United States
(12) Patent Application Publication
(10) Pub. No.: US 2026/0150124 A1
(43) Pub. Date: May 28, 2026

(54) SYSTEMS, METHODS, AND DEVICES FOR CQI OF A COMPONENT CARRIER (CC) GROUP

(71) Applicant: Apple Inc., Cupertino, CA (US)

(72) Inventors: Srinivasan BALASUBRAMANIAN, San Diego, CA (US); Sreevalsan VALLATH, Dublin, CA (US); Tarik TABET, Carlsbad, CA (US); Sairamesh NAMMI, San Diego, CA (US)

(21) Appl. No.: 19/397,666

(22) Filed: Nov. 21, 2025

Related U.S. Application Data
(60) Provisional application No. 63/724,251, filed on Nov. 22, 2024.

(51) Int. Cl. H04W 72/542; H04L 5/00

(52) U.S. Cl. CPC H04W 72/542; H04L 5/0053

(57) ABSTRACT

Described herein are techniques for determining a channel quality indicator (CQI) associated with a group of component carriers (CCs). A user equipment (UE) and base station can implement carrier aggregation (CA) across a group of CCs. The base station can provide the UE with configuration information that enables the UE to measure a signal quality of different CCs, of the CC group, at different times. The measurement can be based on a channel state information (CSI) reference signal (RS) (CSI-RS). The UE can determine a CQI based on one CC and report the CQI to the base station. The base station can use the CQI to determine a CQI for another CC of the CC group and/or a CQI for the entire CC group. These and many other features and examples are described herein.

### CROSS-REFERENCE TO RELATED APPLICATION

This application claims the benefit of U.S. Provisional Application No. 63/724,251, filed Nov. 22, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations, to communicate with one another. Such communications can involve procedures to synchronize with signaling, measure reference signaling, and provide reports regarding signal measurements.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example of a master cell group (MCG) and a secondary cell group (SCG) according to one or more implementations described herein.

FIG. 4 is a diagram of an example of a process for channel quality indicator (CQI) duty cycling across component carriers according to one or more implementations described herein.

FIG. 5 is a diagram of examples 500 of base stations, cells, and CC group configurations according to one or more implementations described herein.

FIG. 6 is a diagram of an example signal timing according to one or more implementations described herein.

FIG. 7 is a diagram of an example of components of a device according to one or more implementations described herein.

FIG. 8 is a diagram of example interfaces of baseband circuitry according to one or more implementations described herein.

FIG. 9 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 10 is a diagram of a first example process for CQI duty cycling across component carriers according to one or more implementations described herein.

FIG. 11 is a diagram of a second example process for CQI duty cycling across component carriers according to one or more implementations described herein.

FIG. 12 is a diagram of a third example process for CQI duty cycling across component carriers according to one or more implementations described herein.

FIG. 13 is a diagram of a fourth example process for CQI duty cycling across component carriers according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network devices. The UE and base station can communicate with one another to establish wireless resources (e.g., time and frequency resources) to be used to establish a connection between the UE and the base station. The wireless resources can be allocated using carrier aggregation (CA), such that the connection between the UE and the network can include multiple component carriers (CCs). The CCs can involve different cells implemented by one or more base stations.

The CCs can be used to define one or more channels between the UE and the network. The channels can be used to communicate uplink (UL) information from the UE to the network and/or downlink (DL) information from the network to the UE. Managing wireless signaling and resources can involve the determination and reporting of one or more types of information, such as a channel quality indicator (CQI).

A CQI can include information describing or indicating the quality of wireless channel between a UE and a network. Generally, information can include an indication of how well a signal is received and/or how susceptible the signal is to errors and interference. CQI can be represented in decibels (dB). A low value can indicate lesser channel quality, and a high value can indicate greater channel quality.

CQI can be used for adaptive modulation and coding (AMC). For example, the UE can determine and report a CQI to a base station, and the base station can adjust a modulation scheme and coding rate being used by the UE and base station. CQI can also be used to allocate less, more, or different wireless resources to a connection between the UE and network. The UE can determine and report a CQI according to a periodicity that is consistent with network preferences or requirements. Other aspects of network communications for which CQI can be use include interference and noise consideration, link adaptation, real-time adjustment of resources, and wireless resource allocation robustness and efficiency.

Currently available technologies include solutions for evaluating and generating reports about wireless resource allocations. This can include measuring a reference signal (RS), determining a strength of an RS, and communicating a report indicating the strength of the RS. However, currently available technologies fail to provide any, or adequate, solutions for determining and reporting a signal quality associated with multiple CCs.

One or more of the techniques, described herein, include solutions for determining a channel quality indicator (CQI) associated with a group of CCs. A UE and base station can establish a connection using CA that involves a group of CCs. The base station can provide the UE with configuration information that enables the UE to measure a signal quality of different CCs, of the CC group, at different times. The measurement can be based on a reference signal from the base station, such as a channel state information (CSI) RS (CSI-RS). The UE can determine a CQI based on a signal strength or quality of one CC, of the CC group, and report the CQI to the base station. The base station can use the CQI to determine a CQI for another CC of the CC group and/or a CQI for the entire CC group. A group of CCs, a CC group, and similar phrases can refer to the same type of entity or entities of a similar type, such as CCs that have been logically associated with one another to facilitate or otherwise enable communications between a UE and one or more base stations, possibly using CA.

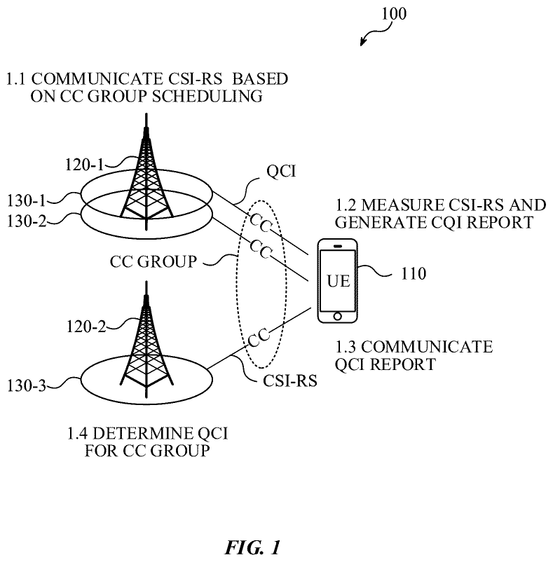

FIG. 1 is a diagram of an example 100 of an overview according to one or more implementations described herein. As shown, example 100 can include UE 110, base station 120-1 and base station 120-2. Base station 120-1 can operate as a first cell 130-1 and a second cell 130-2, and base station 120-2 can operate as a third cell 130-3, which can be referred to collectively as “cells 130.” UE 110 can connect to cells 130 via carrier aggregation (CA) that involve a combination of a CC for cell 130-1, a CC for cell 130-2, and a CC for cell 130-3.

The CCs can comprise a CC group (e.g., a grouping of CCs). In some implementations, a different number and/or arrangement of base stations, cells, and CCs can be implemented. While not shown, UE 110 can receive configuration information base station 120-1, which can include an indication of the CC group, instructions to identify and activate one or more cells 130, and establish CCs with cells 130. The configuration information can also include instructions for receiving a CSI-RS according to a transmission schedule across each CC and for reporting a measurement of the CSI-RS back to base station 120-1.

As shown, base station 120-2 can use a CC of cell 130-3 to send UE 110 a CSI-RS based on scheduling information for the corresponding CC group (at 1.1). UE 110 can measure the CSI-RS and can generate a CQI report based on the measurement (at 1.2). UE 110 can communicate the CQI report to base station 120-1 using a different CC, such as the CC for cell 130-3 (at 1.3). Base station 120-1 can determine a CSI for another CC, or for the entire CC group, based on the CSI received from UE 110 (at 1.4). Accordingly, one or more of the techniques described herein can enable the determination of a CSI for one CC based on a CSI received for another CC of a CC group. These and many other features and examples are described below with reference to the remaining Figures.

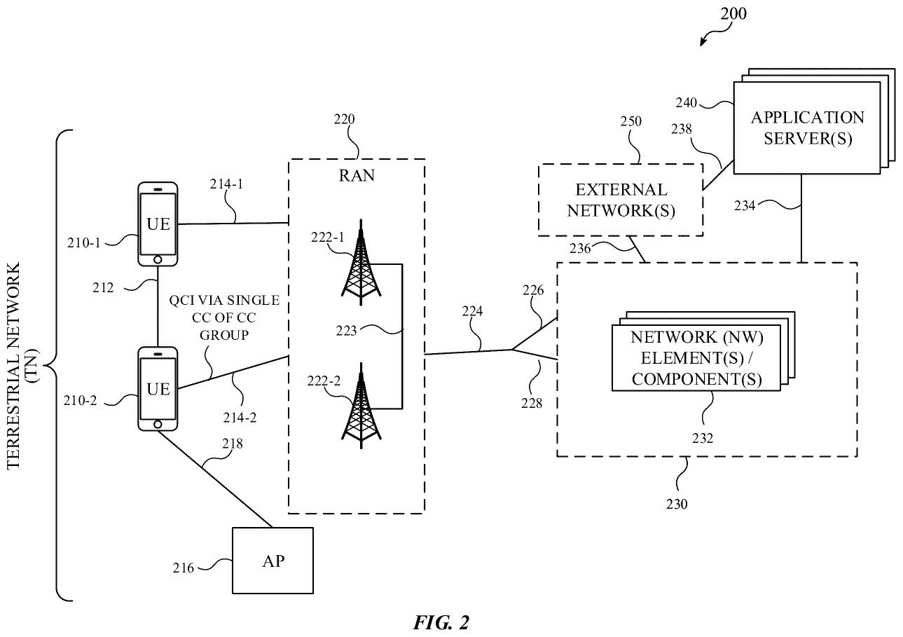

FIG. 2 is an example environment 200 in which one or more of the techniques described herein can be implemented. Example environment 200 can include UEs 210-1, 210-2, etc. (referred to collectively as “UEs 210” and individually as “UE 210”), a radio access network (RAN) 220, a core network (CN) 230, application servers 240, external networks 250.

The systems and devices of example environment 200 can operate in accordance with one or more communication standards, such as 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example environment 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards, and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include Internet of Things (IoT) devices (or IoT UEs) that can implement narrowband (NB) communications and that can comprise, for example, a network access layer designed for low-power IoT applications utilizing short-lived UE connections.

Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

Various techniques for communication between and among UEs 210 in furtherance of offloading or computing operations are within the scope of the present disclosure. As described herein, in an example, UE 210 can communicate with RAN node 222 to request SL resources. RAN node 222 can respond to the request by providing UE 210 with a dynamic grant (DG) or configured grant (CG) regarding SL resources. The UE 210 can communicate with RAN node 222 using a licensed frequency band and communicate with the other UE 210 using an unlicensed or licensed frequency band. In another example, UEs 210 can communicate directly without involvement of RAN node 222, such as through resource pools, etc.

UEs 210 can communicate and establish a connection with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). A network node can be referred to herein as a base station 222. In such a scenario, one network node can operate as a master node (MN) and the other as the secondary node (SN). The MN and SN can be connected via a network interface, and at least the MN can be connected to the CN 230. In some implementations, a base station (as described herein) can be an example of network node 222. In some scenarios, RAN 220 can coordinate with core network 230 via interfaces 224, 226, and/or 228.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection interface 218 can comprise a local wireless connection, such as a connection consistent with any IEEE 802.11 protocol, and AP 216 can comprise a wireless fidelity (Wi-Fi®) router or other access point device. While not explicitly depicted in FIG. 2, AP 216 can be connected to another network (e.g., the Internet) without connecting to RAN 220 or CN 230.

One or more of the techniques described herein include solutions for determining a channel quality indicator (CQI) associated with a group of CCs. UE 210 and base station 222 can establish a connection using CA that involves a group of CCs. Base station 222 can provide UE 210 with configuration information that enables UE 210 to measure a signal quality of different CCs, of the CC group, at different times. The measurement can be based on a reference signal from the base station, such as a CSI-RS. UE 210 can determine a CQI for one CC, of the CC group, and report the CQI to base station 222. Base station 222 can use the CQI to determine a CQI for another CC of the CC group and/or a CQI for the entire CC group. These and many other features and examples are described herein.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells. A RAN node can generally be referred to herein as base station 222.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 1 (L1) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information feedback from any of UEs 210. The downlink resource assignment information can be sent on the PDCCH used for (e.g., assigned to) each of UEs 210.

RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN (5GC), and/or one or more additional or alternative types of CNs.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

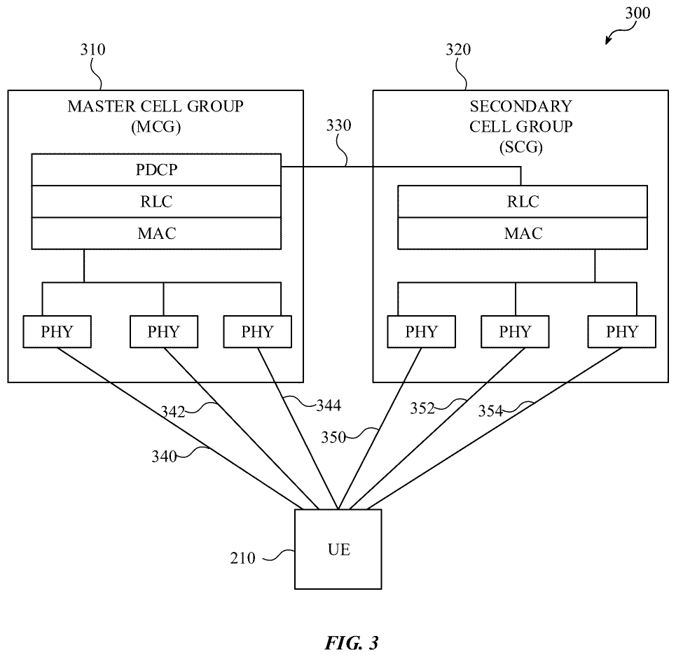

FIG. 3 is a diagram of an example 300 of a master cell group (MCG) 310 and a secondary cell group (SCG) 320 according to one or more implementations described herein. An MCG can include a group of cells associated with a master node, comprising a primary cell (PCell) and one or more secondary cells (SCells). An SCG can include a group of serving cells associated with a secondary node, comprising a primary cell of a secondary cell group (PSCell) and optionally one or more SCells. MCG 310 and SCG 320 can each be implemented by one or more base stations 222 and/or another type of RAN node or network access point.

MCG 310 can be implemented by one or more base stations 222 and can include one or more layers. Examples of such layers can include a PDCP layer, an RLC layer, a MAC layer, and multiple PHY layers. Each PHY layer can correspond to a different implementation of a cell with respect to UE 210. Additionally, or alternatively, the PHY layers can operate in combination (e.g., be managed, controlled by, etc.) the PDCP, RLC, and MAC layers. In some implementations, one PHY layer 340 can operate as a PCell or a special cell (SpCell) and other PHY layers 342 and 344 can operate as SCells to the PCell.

SCG 320 can include multiple layers as well, including an RLC layer, a MAC layer, and multiple PHY layers 350, 352, and 354. SCG 320 may not include a PDCP layer, but instead can rely on the PDCP layer of MCG 310 via connection 330. Similar to the PHY layers of MCG 310, the PHY layers of SCG 320 can each function or operate as a cell with respect to UE 210. In some implementations, one PHY layer 350 can operate as a primary cell (PCell) to PHY layers 352 and 354, which can operate as secondary cells to the PCell of PHY layer 350. Additionally, MCG 310 and SCG 320 can each include a PCell (e.g., 340 and 350), and a PCell can be referred to herein as a special cell or special primary cell, represented as SpCell. Further, a SCell, of either MCG 310 or SCG 320, can operate as a scheduling secondary cell (sSCell) configured to provide configuration, scheduling, activation, deactivation, and other functions or commands toward a SpCell of either MCG 310 or SCG 320.

MCG 310 and SCG 320 can be involved in a dual connectivity scenario with UE 210, in which case a random access channel (RACH) procedure, and the like, can be directed to MCG 310. MCG 310 and SCG 320 can also implement a standalone (SA) and/or a non-standalone (NSA) network environment for UE 210. In a SA network environment, MCG 310 and SCG 320 can communicate with UE 210 using 5G NR communication standards, 6G communications standards, 7G communication standards, and more. In an NSA network environment, MCG 310 and SCG 320 can communicate with UE 210 using a combination of, for example, 4G LTE, 5G NR, and 6G communication standards. In some implementations another combination can be used. Carrier aggregation (CA) can include, for example, a scenario in which UE 210 aggregates component carriers from a PCell under MCG 310 and an SCell under MCG 310. Dual connectivity can include, for example, a scenario in which UE 210 connects to cells under MCG 310 and SCG 320.

One or more of the techniques described herein include solutions for determining a CQI associated with a group of CCs. UE 210 and base station 222 can establish a connection using CA that involves a group of CCs. Base station 222 can be configured to operate as one or more types of cell groups (e.g., MCG 310, SCG 320, etc.) and/or types of cells (e.g., PCell, SCell, PSCell, sSCell, etc.). In some implementations, base station 222 can operate cooperatively or in tandem with one or more other base stations 222, which can be configured to operate as one or more types of cell groups and/or cells.

Base station 222 can provide UE 210 with configuration information that enables UE 210 to measure CCs, of the CC group, at different times. The measurement can be based on a reference signal (e.g., CSI-RS) associated with a particular CC of the CC group. The measurement can include, be related, or based on, one or more types of signal characteristics, such as a received signal strength indicator (RSSI), reference signal received quality (RSRQ), signal-to-interference-plus-noise ratio (SINR), reference signal received power (RSRP), error rate, signal interreference, and/or one or more other types of characteristics of a signal. UE 110 can report the CQI to base station 222, and base station 222 can use the CQI to determine a CQI for another CC of the CC group and/or a CQI for the CC group. These and many other features and examples are described herein. Base station 222 can use the CQI of a CC, CQIs of multiple CCs, and/or a CQI of the CC group to evaluate, manage, update, and/or reallocate CCs and/or other types of wireless resources used by UE 110 and/or base station 222. Additional example of features, operations, information, and procedures are discussed below.

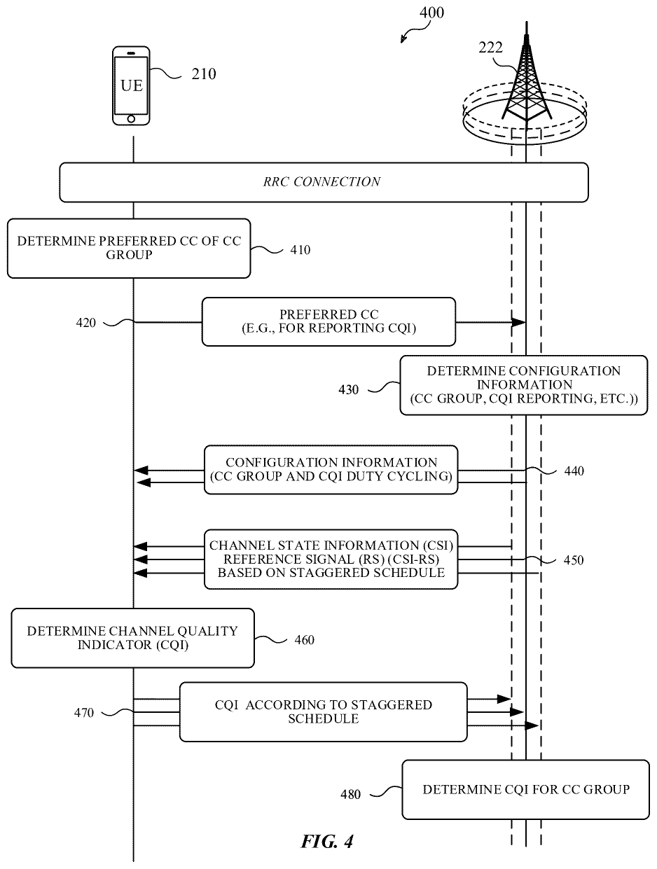

FIG. 4 is a diagram of an example of a process 400 for channel quality indicator (CQI) duty cycling across component carriers according to one or more implementations described herein. As shown, process 400 can be performed by UE 210 and base station 222. Base station 222 can be implemented as one or more base stations 222. Base station 222 can implement one or more cells. Base station 222 can implemented one or more types of cell groups (e.g., MCG 310, SCG 320, etc.) and/or types of cells (e.g., PCell, SCell, PSCell, sSCell, etc.). In some implementations, base station 222 can operate cooperatively, or in tandem, with one or more other base station 222, which can be configured to operate as one or more types of cell groups and/or cells. One or more of the cell groups and/or cells of base station 222 can be implemented as a network energy saving (NES) cell.

Some or all of process 400 can be performed by one or more other systems or devices, including one or more of the devices of FIG. 2. Additionally, process 400 can include one or more fewer, additional, differently ordered, and/or arranged operations than those shown in FIG. 4. Some or all of the operations of process 400 can be performed independently, successively, simultaneously, etc., of one or more of the other operations of process 400. As such, the techniques described herein are not limited to the number, sequence, arrangement, timing, etc., of the operations or processes depicted in FIG. 4.

As shown, process 400 can include UE 210 determining a preferred CC of a CC group (block 410). Base station 222 and UE 210 can perform a CA procedure to establish an RRC connection using multiple CCs. UE 210 can monitor, measure, and/or perform link management with respect to the CCs. UE 210 can determine which CC, of the group of CCs, is preferred for measuring a CSI-RS and/or reporting CSI to a particular cell and/or base station 222. The CSI can include a CQI.

UE 210 can determine the preferred CC based on one or more factors, such as a reference signal received power (RSRP), reference signal received quality (RSRQ), signal interference noise ratio (SINR), and/or one or more other types of factors or characteristics of a signal, including a type of cell associated with the CC (e.g., PCell, SCell, etc.). A footprint associated with one or more cells, a mobility state (e.g., stationary or mobile) of UE 210, and other conditions can be involved in determining the preferred CC. In some implementations, UE 210 can determine the preferred CC by comparing the factors or characteristics of CCs to each other, to one or more thresholds (e.g., signal strength or quality thresholds), and so on. UE 210 can communicate an indication of the preferred CC to base station 222 (block 420). The preferred CC can be preferred for measuring and/or reporting CSI and/or CQI for the CC group.

Process 400 can include base station 222 determining configuration information for UE 210 (block 430). Base station 222 can determine the configuration information based on, at least in part, UE capability information received from UE 210 (not shown). The configuration information can include information relating to a CC group used to communicate between UE 210 and base station 222, CSI-RS downlink transmissions, CSI uplink transmissions, CQI reporting, and more. In some implementations, some or all of the configuration information of block 430 can be determined by base station 222, UE 210, and/or communicated between base station 222 and UE 210 before or after block 430. For example, in some implementations, some or all of the configuration information of block 430 can be communicated to UE 210 while an RRC connection is being established and/or CA procedure is being performed. Additionally, or alternatively, some or all of the configuration information can be communicated via one or more transmissions or signals.

The configuration information can include information to cause or enable UE 210 to communicate with one or more cells using a CC associated with each cell. UE 210 can implement CA prior to, subsequent to, or in repones to receiving the configuration information. The configuration information can include information and/or instructions to cause or enable UE to measure a reference signal associated with a CC of the CC group. The CC group can be configured for CQI reporting, which can be a different set of CCs than a CC group for SSB transmissions and/or CC group for CSI-RS transmissions. The CCs of a CC group can include different combinations of CCs associated with one or more base stations 222. Additionally, or alternatively, CCs of a CC group can include different combinations of CCs associated with one or more types of cell groups (e.g., MCG 310, SCG 320, etc.) and/or types of cells (e.g., PCell, SCell, PSCell, sPCell, sSCell, etc.). The configuration information can include staggering schedule information indicating time domain resources and frequency domain resources for transmitting a staggered CSI-RS to UE 210 using different CCs of the CC group. The configuration information can include information and instructions for determining a CQI based on an CSI-RS of a particular CC and/or reporting the CQI to base station 222 via the CC or another CC of the CC group.

Process 400 can include base station 222 communicating the configuration information to UE 210 (block 440). The configuration information can include information and instruction for duty cycling across CCs of a CC group according to a staggered schedule. A duty cycle can pertain to the transmission of a given type of information, data structure, channel, signal, and/or one or more other types of entities. A CSI-RS duty cycle can include CSI-RS transmissions across CC of a CC group according to a staggering schedule. A CQI duty cycle can include CQI transmissions across CC of a CC group. CQI can be reported in CSI.

The CSI assessment across CCs of a CC group can be performed on the downlink. The assessed, measured, and/or derived information can be transmitted on any available uplink channel as part of the CSI report sent from UE 210 to base station 222. A CQI duty cycle can be referred to herein as a CSI duty cycle carried out according to a CQI staggered schedule or a CSI staggered schedule. In some implementations, a CQI duty cycle or CQI staggered schedule can be determined by applying an offset to an CSI-RS duty cycle or CSI-RS duty cycle staggered schedule, or vice versa.

Process 400 can include base station 222 communicating CSI-RS to UE 210 according to a staggered schedule (block 450). The staggered schedule can be a CSI-RS staggered schedule, which may also be referred to herein as a “staggered CSI-RS transmission schedule”. The CSI-RS staggered schedule can be indicated by configuration information provided to UE 210 by base station 222. The CSI-RS staggered schedule can be based on, or configured to be in accordance with, a staggered schedule for reporting CSI and/or CQI to base station 222. For example, base station 222 can provide UE 210 with a staggered schedule for reporting CQI across CCs of a CC group (which may also be referred to herein as a “staggered CQI reportiong schedule”), and UE 210 can determine the staggered schedule for receiving CSI-RS based on the staggered schedule for reporting CQI.

Process 400 can include UE 210 determine a CQI (block 460). For example, UE 210 can measure a signal strength of a CSI-RS associated with a particular CC of the CC group. UE 210 can determine the CQI for the CC based on the measured signal strength. In some implementations, UE 210 can determine the CQI based on one or more additional, or alternative, factors, characteristics, or conditions, such as a RSSI, RSRQ, SINR, RSRP, error rate, signal interreference, signal-to-noise ratio (SNR), and/or one or more other types of factors, characteristics, or conditions. In some implementations, UE 210 can be configured to determine the CQI for the preferred CC (e.g., as opposed to another CC of the CC group).

Process 400 can include UE 210 communicating the CQI to base station 222 (block 470). UE 210 can generate CSI report (comprising CSI) based on the CSI-RS and/or measurements of the CSI-RS. The CSI can include the CQI (or a CQI report). A CQI report can include a CQI, precoding matrix indicator (PMI), rank indicator (RI), signal-to-interference-plus-noise ratio (SINR), and more, which can be based on measurements of the CSI-RS from base station 222. UE 210 can communicate the CSI report with the CQI according to a staggered schedule associated with communicating CSI and/or CQI for the CC group. The CQI can be communicated using the CC associated with the CSI-RS or another CC of the CC group.

The reporting of CSI information can be done on any available uplink channel. The information can include one CC of the CC group for which the measurement was made or can include information assessed for multiple CCs in the CC group with the measurements performed based on the staggered CSI-RS transmitted by the CCs in the CC group. In some implementations, the CQI can be reported using the preferred CC and/or a CC associated with a particular cell or cell type (e.g., a CC of a PCell, SCell, sPCell, etc.). UE 210 can receive CSI-RS from other CCs and determine and report CQIs for the CCs according to staggered schedules for CSI-RS and/or CQIs. UE 210 can reporting CSI information immediately, or otherwise soon, after sensing the staggered CSI-RS for a CC in a CC group. In some implementations, UE 210 can combine CSI information measured and/or derived from different CCs and report the combined CSI information for multiple CCs in the CC group.

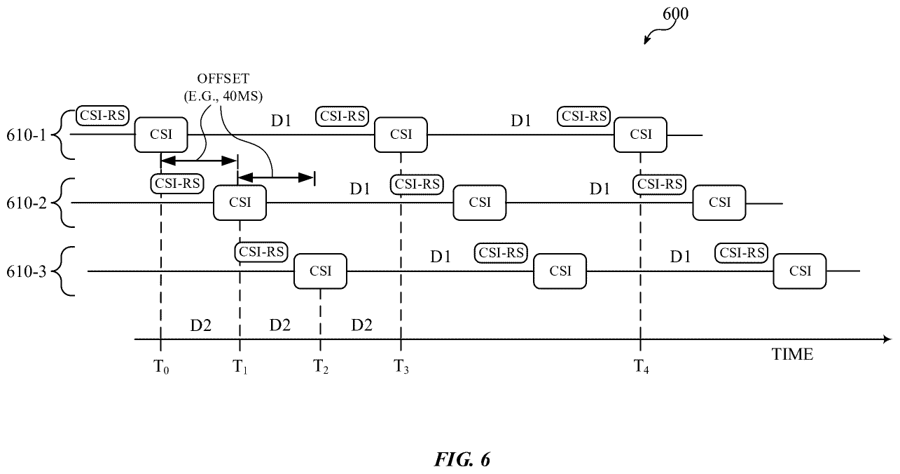

Process 400 can include base station 222 determining a CQI for the CC group (block 480). For example, base station 222 can receive the CQI for a particular CC from UE 210. Base station 222 can derives a CQI for one or more other CCs of the CC group based on the CQI for the particular CC. In some implementations, base station 222 can determine a CQI for the entire CC group based on the CQI received from UE 210. Examples of determining a CQI for CCs of a CC group based on the CQI associated with one CC are described in detail below with reference to FIG. 6 (see, for example, Option 1, Option 2, Option 3, and so on).

The CCs of a CC group can be staggered, with respect to one another, according to a staggering schedule, A staggering schedule can be referred to as a transmission schedule, reception schedule, or another type of sequence, pattern, or relativistic framework. A staggering schedule can include one or more types of time domain characteristics, such as a periodicity, offset, time delay, timer, reset timer, time gap, measurement gap, timing window, etc. Different staggering schedules can have the same, different, different combination, and/or a different number of time domain characteristics.

Additionally, or alternatively, the values of a particular type of characteristic, within a particular staggering schedule or between different staggering schedules, can vary. For example, the value of an offset associated with one instance of an CSI-RS can be different than an offset associated with another instance of an CSI-RS of the same CC or CC group. Different staggering schedules can be associated with different types of information. For example, UE 210 and base station 222 can use a first staggering schedule for synchronization signal blocks (SSBs), a second staggering schedule for CSI-RS transmissions, and a third staggering schedule for CQI transmissions. In some implementations, a staggering schedule can be used for more than one type of signal and/or information. For example, a first staggering schedule can be used for SSBs, while a second staggering schedule can be used for both CSI-RS transmissions and CQI transmissions.

In such a scenario, UE 210 and/or base station can determine time and frequency resources for one type of transmission based on another type of transmission. For example, the staggering schedule can provide an explicit transmission times for CSI-RS transmissions and the transmission times for CQI transmissions can be inferred or determined based on the transmission times of the CSI-RS transmissions (e.g., a CQI can be transmitted upon expiration of a specified duration measured from the most recent CSI-RS transmission). Frequency resources can also, or alternatively, be determined relative to the frequency resources of another type of transmission (e.g., the CC for transmitting a CQI can be determined to be a next, current, or most recent CC relative to the CC used for a next, current, or most recent CSI-RS transmission.

The staggering schedule can indicate time domain and/or frequency domain resources allocated for the transmission and/or reception of one or more types of signals or information, and/or performance of one or more types of operations. For example, a staggering schedule can indicate time domain resources associated with the transmission and/or reception of a reference signal (e.g., a CSI-RS). As another example a staggering schedule can also, or alternatively, indicate frequency domain resources associated with the transmission and/or reception of one or more types of signals or information. Examples of the frequency domain resources can include one or more carriers, CCs, channels, subchannels, bandwidths, bandwidth parts (BWPs), and/or one or more other types of frequency domain resources.

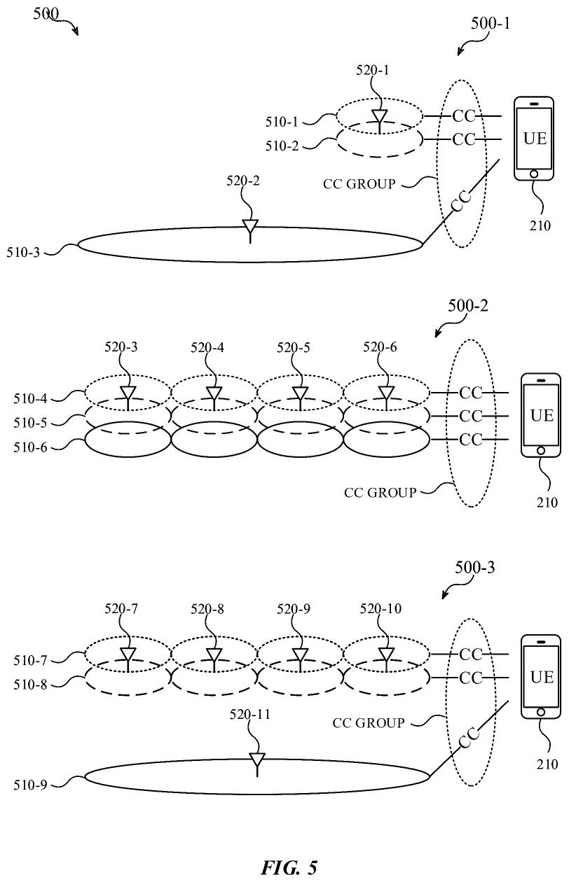

FIG. 5 is a diagram of examples 500 of base station, cell, and CC group configurations according to one or more implementations described herein. As shown, example CC group layouts 500 can include CC group layout 500-1, CC group layout 500-2, and CC group layout 500-3. Example CC group layouts 500 can each include groups of CCs. For example, CC group layouts 500 can each include a different variation for how CCs can be implemented in a network. CC group layouts 500 can include representative variations of a quantity of possible variations that can be implemented by a network. One or more of examples 500 can be applied or implemented within the context of one or more other examples described herein. For instance, one or more of examples 600-1, 600-2, and 600-3 can be applied to one or more of examples 100, 400, 600, 1000, 1100, etc., as described herein.

In some implementations, CQI reporting can involve or prefer finer control information for appropriate scheduling such that CCs suitable for CQI reports are to be grouped closely together CCs. In some implementations, the CCs for CQI reports are not co-located or are not configured with the same or similar footprint. Instead, the CC can be configured to support deployment scenarios that allow or enable CQI reported by one CC to be leveraged for CQI derivation for other CCs of the CC group.

The configuration information determined by base station 222 and transmitted by base station 222 to UE 210 can include one or more types of information. An example of such information can include a CC-GroupForCSI IE can define, indicate, or configure a set of CCs that support coverage across vertical frequencies in a given footprint and accommodate CQI information reported from one of the CCs of the CC group (e.g., as indicated by IE CC-GroupForCSI) to allow for CQI for the other CCs of the CC group to be derived. The CC group of the CC-GroupForCSI IE can be a subset of the CC-GroupForSSB IE. The subset of the CC-GroupForSSB IE can include both a proper subset (e.g., a smaller set) and an improper subset (e.g., the full set). In some implementations, a CC-GroupForCQI IE can include some or all of the information, and enable some or all of the functionality, described as being provided by the CC-GroupForCSI IE. In some implementations, information described as being included in the CC-GroupForCSI IE, and/or the functionality being enabled thereby, can be provided and enabled by a combination of the CC-GroupForCSI IE and a CC-GroupForCQI IE.

Referring to example 500, CC group layouts 500 can each include a group of CCs (or CC group) that can be implemented by one or more base stations 222 for communicating with a UE 210. Entity 520-1, entity 520-2, . . . entity 520-11 can each include one or more base stations 222. Each CC group can be defined by a CC-GroupForSSB IE and can be configured to leverage SSBs communicated on individual CCs of the CC group. For example, a CC-GroupForSSB IE can include a set of CCs that supports a coverage across vertical frequencies in a given footprint. In some implementations, the CC-GroupForSSB IE can be changed based on a NES function of individual CCs. For instance, a CC of the CC-GroupForSSB IE can slow a transmission rate (e.g., to 160 ms) of the SSBs due to a lack of congestion within the CC group of the CC-GroupForSSB IE. In some implementations, a cadence for transmitting SSBs and the selection of CCs to be included in the CC-GroupForSSB IE can be dynamically determined by base station 222 and broadcast information can be adjusted accordingly.

The CC group layout 500-1, the CC group layout 500-2, and the CC group layout 500-3 each include a quantity of sites 520, where each site 520 can be an example of base station 222. As shown in FIG. 5, each site 520 can be associated with one or more CCs. For example, site 520-3, site 520-4, site 520-5, and site 520-6 are each associated with three respective CCs; site 520-1, site 520-7, site 520-8, site 520-9, and site 520-10 are each associated with two respective CCs; and site 520-2 and site 520-11 are each associated with one respective CC. A footprint, as referred to herein, can include one or more coverage areas of a cell or cells, one or more sites of a cell or cells, and so on.

Each site 520 can be associated with one or more cells 510, which can be examples of PCells, SCells, PSCells, sPCells, sSCells, or neighboring cells. For example, site 520-3, site 520-4, site 520-5, and site 520-6 are each associated with three respective cells 510 (e.g., cell 510-4, cell 510-5, cell 510-6); site 520-1, site 520-7, site 520-8, site 520-9, and site 520-10 are each associated with three respective cells 510 (e.g., cell 510-1, cell 510-2, cell 510-7, cell 510-8); and site 520-2 and site 520-11 are each associated with one respective cell 510 (e.g., cell 510-3, cell 510-9). For example, when UE 210 is camped on a site 520-7 (e.g., within a coverage area of the site 520-7), the site 520-7 can function as a PCell for UE 210. In some implementations, the site 520-7 can function as PSCell or an SCell for UE 210 based on the site 520-7 being associated with other cells. In other examples, the site 520-8 or the site 520-11 can function as an SCell or a neighboring cell for UE 210.

In some scenarios, the sites 520 can be collocated or non-collocated, such that site 520-7 can be collocated with site 520-8 but non-collocated with site 520-11. In some scenarios, the collocated sites 520 can leverage SSBs transmitted via CCs of the same group of CCs. For example, UE 210 can receive SSBs via CCs associated with the collocated sites 520-7 and 520-8. However, in some cases, the network may not guarantee support for UE 210 receiving SSBs via CCs associated with non-collocated sites 520-7 and 520-11.

In some scenarios, the sites 520 can be associated with different systems, such an FDD system or a TDD system. For example, a site 520 operating as an FDD system can be associated with a larger coverage area or footprint (e.g., from base station 222) than a site 520 operating as a TDD system. In some implementations, UE 210 can be camped on a site 520 operating as a TDD system, and UE 210 can monitor a neighboring site 520 operating as a FDD system. Further, UE 210 camped on a site 520 operating as an FDD system can be operable to monitor a neighboring site 520 operating as a TDD system.

In some implementations, UE 210 can leverage SSBs communicated from a quantity of neighboring sites 520 operating as TDD systems. In some scenarios, a site 520 operating as an FDD system can be configured to support transmissions that are asynchronous. For example, SSBs can be communicated asynchronously from a site 520 operating as an FDD system to UE 210. In some scenarios, a site 520 operating as a TDD system can be configured to support transmissions that are synchronous, such that SSBs can be transmitted synchronously from the site 520 to UE 210. In some examples, although SSBs can be transmitted asynchronously for a site operating as an FDD system, a timing between the site and another site operating as a TDD system can be coarsely aligned by UE 210.

In some scenarios, each site 520 can be configured to deploy multiple CCs in a given footprint such that the CCs can share antenna configurations spanning across frequency bands. For example, each CC in a mid-band frequency can be associated with 32 transmission antennas, whereas each CC in a low-band frequency can be associated with 4 transmission antennas. In some implementations, UE 210 can be configured to report RSRP, RSRQ, or SINR for a CC within a frequency band. In some implementations, the RSRP, RSRQ, and SINR for a CC within a frequency band can correlate to the RSRP, RSRQ, and SINR for other CCs within the frequency band.

UE 210 can be configured to leverage SSBs communicated via an individual CC of the group of CCs. For example, UE 210 can be camped on a site 520-1 and can establish and maintain a connection with the site 520-1 using a CC of the group of CCs associated with the site 520-1. In some implementations, UE 210 can leverage the connection with the site 520-1 using the CC to communicate with the site 520-1 using other CCs of the group of CCs. That is, with overlapping footprints across the group of CCs, UE 210 can leverage SSBs available via another CC of the group, even if UE 210 is camped on a given frequency.

FIG. 6 is a diagram of an example signal timing according to one or more implementations described herein. Example 600 can be applied or implemented with the context of one or more other implementation, examples, or scenarios described herein. One or more of examples 500 can be applied or implemented within the context of one or more other examples described herein. For instance, one or more of examples 600-1, 600-2, and 600-3 can be applied to one or more of examples 100, 400, 500, 1000, 1100, etc., as described herein.

Example signal timing 600 includes a staggered schedule for communicating CSI via CCs 610 (e.g., CC 610-1, CC 610-2, CC 610-3) between a UE (e.g., UE 210) and one or more cells (e.g., base stations 222). UE 210 can receive a CSI-RS via a CC of a CC group (e.g., one of CCs 610). UE 210 can measure a signal strength of the CSI-RS. UE 210 can generate CSI (e.g., a CSI report) based on the measured signal strength. This can include UE 210 determining a CQI and including the CQI (and/or a CQI report) in the CSI). UE 210 can communicate the CQI report in the CSI to the network according to the staggered schedule of Example signal timing 600. The CSI-RS can be transmitted according to a CSI-RS staggered schedule, which can track a CSI staggered schedule or staggered schedule CQI, such that a CQI based on a CSI-RS can be promptly reported.

Example signal timing 600 includes communicating (e.g., transmitting) a series of CSI (e.g., three CSI) on each CC 610 based on the staggered schedule. For each CC 610, a duration D1 can elapse between the communication of each CSI of the series of CSI. For example, a second CSI of the series can be communicated after the duration D1 has elapsed since communicating a first CSI of the series, and a third CSI of the series can be communicated after the duration D1 has elapsed since communicating the second CSI of the series.

For example, a first CSI of the series of CSI communicated on CC 610-1 is included at a time T0, a second CSI of the series is included at a time T3, and a third CSI of the series is included at a time T4, where the duration D1 is included between the time T0 and the time T3 and between the time T3 and the time T4. In some implementations, the duration D1 can be a fixed value (e.g., 120 milliseconds (ms)) or a value dynamically configured by the network or UE 210. Although example signal timing 600 includes each series of CSI as including three CSI, it should be understood that the CSI staggered schedule or CQI staggered schedule described herein can include more or fewer CSI/CQI reporting instances.

Each series of CSI and/or CSI can be offset (e.g., staggered) from one another. That is, the series of CSI communicated on CC 610-3 can be offset from the series of CSI communicated on CC 610-2, which can be offset from the series of CSI communicated on CC 610-1. For example, a first CSI (e.g., a second CSI, a third CSI) of the series of CSI communicated on CC 610-3 can be offset (e.g., 40 ms) from the first CSI on CC 610-2, which can be offset from the first CSI on CC 610-1 (e.g., another 40 ms). In some implementations, different offset durations can be used.

In some examples, each series of CSI can be offset by a duration D2, such that the series of CSI communicated on CC 610-3 can be offset from the series of CSI communicated on CC 610-2 by the duration D2, and the series of CSI communicated on CC 610-2 can be offset from the series of CSI communicated on CC 610-1 by the duration D2. For example, a first CSI-RS of the series of CSI communicated on CC 610-1 is included as being communicated at time T0, and the first CSI-RS of the series of CSI communicated on CC 610-2 is included as being communicated at time T1, where the time T1 is offset from the time T0 by the duration D2. Likewise, a first CSI-RS of the series of CSI communicated on CC 610-3 is included as being communicated at time T2, where the time T2 is offset from the time T1 by the duration D2 (e.g., offset from the time T0 by the duration 2*(D2)).

In some scenarios, a CSI-RS of each CC 610 can be communicated within the duration D1 such that the offset between CSI-RSs of different series is a factor of the duration D2. For example, the duration D2 is a factor of the duration D1, such that each duration D1 is associated with three durations D2. That is, the second CSI-RS of a series can be offset from the first CSI-RS of a different series by the duration D2. For example, the second CSI-RS of the series of CSI communicated on CC 610-1 is offset from the first CSI-RS of the series of CSI communicated on CC 610-3 by the duration D2. That is, the time T3 is offset from the time T2 by the duration D2. In some examples, the duration D2 can be a fixed value (e.g., 40 ms) or a value dynamically configured by the network or the UE.

As described herein, when base station 222 determines CSI-RS based CQI reporting is preferred or is otherwise to be implemented by UE 210, base station 222 can provision CSI-RS transmissions on different CCs of the CC group (e.g., as indicated by the IE CC-GroupForCSI) to match with a duty cycling of the CQI reported from the CCs. The CSI-RS tones can be made available prior to the CQI reporting schedule (e.g., staggering schedule) for the associated CCs. When CSI-RS transmissions and CQI transmissions are aligned at or within a corresponding threshold, UE 210 can report a CQI based on more recent measurements of the CSI-RS (e.g., more recent CSI-RS measurements). CQI information that is generated and reported can be based on a measured signal strength associated with CSI-RS resources provided to UE 210 by base station 222.

While an RRC connection is established between UE 210 and base station 222, base station 222 can identify or determine the CCs associated with the CC group (e.g., as indicated by an IE, such as CC-GroupForCSI). Based on one or more factors, such as cell footprints corresponding to CCs of a CC group, channel bandwidth and frequencies used, and more, CCs can experience similar radio channel conditions, encounter similar fading scenarios, and more. Base station 222 can receive UE preferences information relating to CA and/or CCs, which can indicate explicitly or implicit which CCs can be used as a CC group (e.g., for SSB/CQI). This information can also, or alternatively, be shared explicitly and/or implicitly, as well as in advance, as UE capability information when the actual channel combinations are known to UE 210.

A UE preferences information, relating to CCs and/or which CCs can be selected or otherwise designated as part of a CC group, can be provided or determined by base station 222 as part of a CA configuration procedure. UE 210 can provide UE preferences information as part of measurement reports prior to the CA configuration. The UE preferences information can also be provided or indicated to base station after CA is configured at UE 210 and/or changed dynamically based on specific network or operating conditions (e.g., a state of mobility, non-mobility, etc.).

Base station 222 can create a CC group that comprises the selected, identified, or designated CCs. Base station 222 can send UE 210 an indication (e.g., configuration information) of the CC group and/or CCs of the CC group. The CCs can be grouped together for CQI feedback information provided to the network. The desire will be to continue supporting feedback from the individual CCs, but employ: a duty cycling across CCs within a CC-group for CQI reports and maintain a certain cadence for each CC. The information reported from one CC can be applied towards the CQI determination of other CCs in the CC group. The assessment for the CQI for the other CCs can be based, for example, on one or more of the following options.

Option 1: Use the CQI reported for the associated CC. Option 2: Directly use the same value provided for the CC reported if the latest reported rank on one CC in the group is equal to the previously reported rank in the other CC in the carrier group. For example, the CCs of a CC group can be ranked relative to one another. When a CQI is reported for a particular CC, the CQI can be applied to other CCs of the CC group with the same CC rank. Option 3: Use the reported value for the CC and also subject it to the value reported for the given CC from before using a filter using the reported CC and CC for which CQI is being determined. The CQI reported for a given CC can be leveraged for another CC when the precoding matrix indicators (PMIs) match between the CC.

A CQI can include a measure of the channel quality as perceived by UE 210 and/or an indication of the highest modulation and coding scheme (MCS) that UE 210 can reliably decode. For example, a higher CQI value can correspond to better channel conditions, allowing the network to use a higher MCS. A PMI can suggest or indicate a preferred precodig matrix or beamforming weights for a downlink transmission. The PMI can be used in systems with multiple input multiple output (MIMO) or beamforming capabilities. The PMI can enable base station 222 to optimize spatial multiplexing and/or signal quality. A rank (or rank indicator) can indicate or represent the number of spatial layers the UE can support given current channel conditions. A higher RI value indicates a richer scattering environment, allowing multiple data streams to be transmitted simultaneously (spatial multiplexing). When the PMIs match, a filter consistent with the follow can be applied.

$${CQI}_{CC} = α * {CQI}_{Reported - C C} + ( 1 - \_α ) * CQ {I}_{P r e v i o u s - C Q I - F o r - C C}$$

Where, α can be a tunable parameter subject to real-time biases seen between CCs and also subject to the extent duty cycling is performed; CQIReported-CC can be the CQI for the CC for which a report is received; and CQIPrevious-CQI-For-CC can be the previous CQI received from UE 210 for which the CQI is being determined. The value of CQIPrevious-CQI-For-CC can be filtered across multiple past reports received for the same CC. CQICC can be a CQI value for the CC being determined.

Option 4: signal-to-noise (SNR) based method. When the rank information of a current reporting is different from a previous report from the CC group, SNR filtering can be used. For example CQI-rank can be mapped to an SINR using a pre-defined table, and a CQI for the reported rank can be obtained from the SINR. The report can include a positive value or a negative value (+/−δ) from a reference value for other CCs (e.g., δ can be expected to be 1 or 2). A “+/−δ from previous” value or CC can be applicable when a there is a strong correlation across the CC within a corresponding CC (e.g., δ can be expected to be 1 or 2).

The CQI information to be reported and the subsequent CQI reports to be done as a δ from the previous report. The techniques described herein can involve applying the δ of a given CC in the CC group relative to the previous report sent for one of the (other) CCs in the CC group. Further, as the channels across the CCs in a CC group can have a strong correlation, the δ value can dither around the value reported for one of the CCs in the CC group. It can be expected that the δ is to be a +/−{0, 1,2} value from the previous report. These can be index entries and/or can represent smaller changes relative to each other. This approach can allow for quicker channel estimation by using the value from the previous CC reported value for the current CC as part of the duty cycled procedures.

As such, one or more of the techniques described herein can allow, support, or enable enhanced channel assessment, particularly for medium Doppler® and for high-speed channels, and better assessment of the CQI for accounting for an individual CC pertaining the different mobility conditions. Base station 222 can assess as mobility condition of UE 210 and determine or otherwise assess an issue based on CQI derivation procedures using the CQI of different CCs.

Independent of the CQI derivation, the network scheduler may make decisions on the extent of reliance on the CQI based on other sustained metrics like packet error rate (PER) and/or residual block error rate (BLER) and make a decision or determination regarding a modulation and coding scheme (MCS). Such outer loop metric assessment can be based at the PHY layer, MAC layer, or RLC/PDCP layers, including maintaining such metrics associated with the individual CCs or packet received across multiple or all CCs. The a decision or determination of filters and parameters similar to decisions or determinations made for the suggested filter above can be derived based on the outer loop metrics that are determined. Similar techniques can be applied towards other choices made regarding filters.

Base station 222 can also, or alternatively, make a decision or determination based on the services currently active and one or more of the quality of service (QoS) flows established. Based on an expected latency and throughput of currently active services, a more conservative decision or determination regarding the MCS can be made while ensuring that system capacity is not overly or adversely impacted.

One or more operations or functionalities of UE 210 can be optimized by implementing one or more of the techniques described herein. This can involve adapting an individual CC link management reading of an SSBs across CCs of a CC group. Given the CCs belong to a CC group of the CC-GroupForSSB IE, UE 210 can be configured to use that information to determine link maintenance for all CCs together based on an SSB received from the individual CC. One or more of the CCs can experience connectivity issues and that information can be tracked by UE 210 based on the SSBs received for a given CC. This can result in a delayed declaration of failure on a CC; however, by implementing one or more of the techniques described herein, this may not be an issue given that the other CCs of the CC-GroupForSSB IE can be used to maintain the connectivity with the network. Specific behaviors can be configured to be handled for PSCells. A PCell and SCell swap can be requested by UE 210 or proactively handled by base station 222 to address such scenarios of a PSCell failure while the SCells are functional.

One or more operations or functionalities of UE 210 can be optimized as a CQI determination in the UE is done based on CSI-RS in the CC-GroupForCSI IE information that is duty cycled across the CCs associated with the CC-GroupForCSI IE. The duty cycling of the CQI reports sent to the network for the individual CCs of the CC-GroupForCSI IE can be aligned with the duty cycled CSI-RS resources provided for the CCs in the CC-GroupForCSI based on the UL grants provided to UE 210 by the network. This CSI reporting can be done for each CC or can be combined for reporting in a single UL grant. UE 210 can follow the CQI reporting cadence as specified by the network for the CCs in a CC group of the CC-GroupForCSI IE.

Example signal timing 600 includes duty cycling the CSI-RSs across the CCs 610 (e.g., which can be facilitated by the network) to aid NES. That is the signal timing 600 includes CSI-RSs being communicated on CCs 610 such that a UE can receive CSI-RSs with a same periodicity as previous implementations (e.g., current deployments). For example, in traditional applications, CSI-RSs can be transmitted along each CC 610 at a rate of 40 ms. However, because the UE can leverage CSI-RSs from individual CCs 610 of the CC group (e.g., including CC 610-1, CC 610-2, CC 610-3) while the network is operating the CCs 610 in a collaborative manner, the CSI-RSs can be staggering within the CC group such that the UE can receive a CSI-RS from one of the CCs 610 of the CC group every 40 ms, even though each CC 610 is transmitting CSI-RSs at an individual rate of 120 ms. Implementing the techniques described herein can enable a network to reduce (e.g., compared to previous implementations) the periodicity of communicating CSI-RSs on a given CC 610, thereby supporting NES.

The network can be capable of configuring the staggering schedule for communicating the CSI-RSs via the CCs 610. For example, the network can determine a CSI-RS is selected for performing mobility measurements at the UE, and the network can provision the CSI-RSs for the CCs 610 of the CC group (e.g., the CC-GroupForCSI-RS) such that the CSI-RS is aligned with the duty cycling of the CSI-RSs. In some scenarios, the network can configure the staggering schedule to account for the CSI-RSs being available for performing mobility measurements. In some such scenarios, the CSI-RSs can be scheduled such that the CSI-RSs are available prior to a reporting schedule of the mobility measurements for a given CC 610. That is, the UE can be configured to communicate mobility measurement reports based on a cadence defined by the staggering schedule of the CSI-RSs and provided by the network. Additionally, or alternatively, the CSI-RSs can be aligned to support measurement gaps for reporting the mobility measurements in accordance with the reporting schedule. The techniques described herein can support reporting from the UE based on using the relatively most recent CSI-RS for performing mobility measurements.

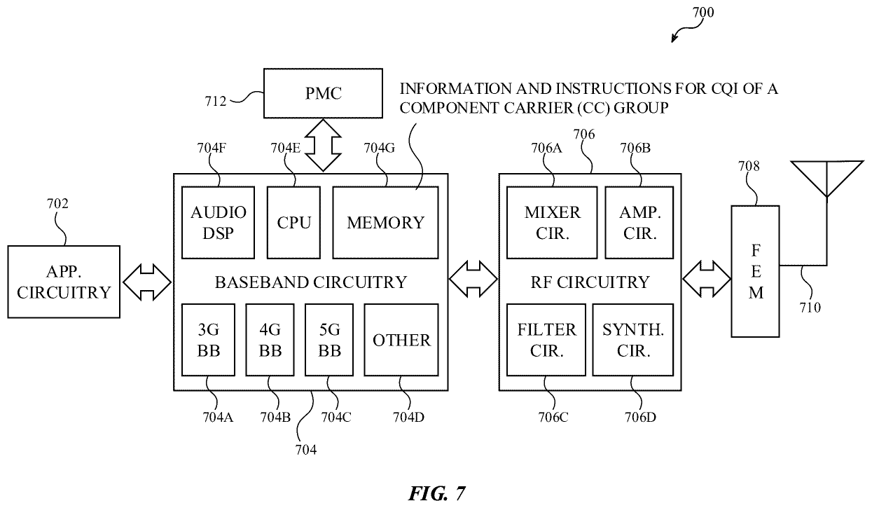

FIG. 7 is a diagram of an example of components of a device according to one or more implementations described herein. In some implementations, device 700 can include application circuitry 702, baseband circuitry 704, RF circuitry 706, front-end module (FEM) circuitry 708, one or more antennas 710, and power management circuitry (PMC) 712 coupled together at least as shown. In some implementations, device 700 can include fewer elements (e.g., a RAN node may not utilize application circuitry 702 and can instead include a processor/controller to process data received from a core network. In some implementations, device 700 can include additional elements such as, for example, memory/storage, display, camera, sensor (including one or more temperature sensors, such as a single temperature sensor, a plurality of temperature sensors at different locations in device 700, etc.), or input/output (I/O) interface. In other implementations, the components described below can be included in more than one device (e.g., said circuitries can be separately included in more than one device for cloud-RAN (C-RAN) implementations).

Application circuitry 702 can include one or more application processors. For example, application circuitry 702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 700. In some implementations, processors of application circuitry 702 can process data packets received from a core network.

Baseband circuitry 704 can include circuitry such as, but not limited to, one or more single-core or multi-core processors. Baseband circuitry 704 can include one or more baseband processors or control logic to process baseband signals received from a receive signal path of RF circuitry 706 and to generate baseband signals for a transmit signal path of RF circuitry 706. Baseband circuitry 704 can interface with application circuitry 702 for generation and processing of the baseband signals and for controlling operations of RF circuitry 706. For example, in some implementations, baseband circuitry 704 can include a 3G baseband processor 704A, a 4G baseband processor 704B, a 5G baseband processor 704C, or other baseband processor(s) 704D for other existing generations, generations in development or to be developed in the future (e.g., 5G, 6G, 7G, etc.). Baseband circuitry 704 (e.g., one or more of baseband processors 704A-D) can handle various radio control functions that enable communication with one or more radio networks via RF circuitry 706. In other implementations, some or all of the functionality of baseband processors 704A-D can be included in modules stored in memory 704G and executed via a central processing unit (CPU) 704E. The radio control functions can include, but are not limited to, signal modulation/demodulation, encoding/decoding, radio frequency shifting, etc. In some implementations, modulation/demodulation circuitry of baseband circuitry 704 can include Fast-Fourier Transform (FFT), precoding, or constellation mapping/de-mapping functionality. In some implementations, encoding/decoding circuitry of baseband circuitry 704 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 704G can receive and/or store information and instructions for determining a channel quality indicator (CQI) associated with a group of CCs. UE 210 and base station 222 can establish a connection using CA that involves a group of CCs. Base station 222 can provide UE 210 with configuration information that enables UE 210 to measure a signal quality of different CCs, of the CC group, at different times. The measurement can be based on a reference signal from the base station, such as a CSI-RS. UE 210 can determine a CQI for one CC, of the CC group, and report the CQI to base station 222. Base station 222 can use the CQI to determine a CQI for another CC of the CC group and/or a CQI for the entire CC group. Many other aspects and examples are also described herein.

In some implementations, baseband circuitry 704 can include one or more audio digital signal processor(s) (DSP) 704F. Audio DSP 704F can include elements for compression/decompression and echo cancellation and can include other suitable processing elements in other implementations. Components of baseband circuitry 704 can be suitably combined in a single chip, a single chipset, or disposed on a same circuit board in some implementations. In some implementations, some or all of the constituent components of baseband circuitry 704 and application circuitry 702 can be implemented together such as, for example, on a system on a chip (SOC).

In some implementations, baseband circuitry 704 can provide for communication compatible with one or more radio technologies. For example, in some implementations, baseband circuitry 704 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 704 is configured to support radio communications of more than one wireless protocol can be referred to as multi-mode baseband circuitry.

RF circuitry 706 can enable communication with wireless networks using modulated electromagnetic radiation through a non-solid medium. In various implementations, RF circuitry 706 can include switches, filters, amplifiers, etc., to facilitate the communication with the wireless network. RF circuitry 706 can include a receive signal path which can include circuitry to down-convert RF signals received from FEM circuitry 708 and provide baseband signals to baseband circuitry 704. RF circuitry 706 can also include a transmit signal path which can include circuitry to up-convert baseband signals provided by baseband circuitry 704 and provide RF output signals to FEM circuitry 708 for transmission.

In some implementations, the receive signal path of RF circuitry 706 can include mixer circuitry 706A, amplifier circuitry 706B and filter circuitry 706C. In some implementations, the transmit signal path of RF circuitry 706 can include filter circuitry 706C and mixer circuitry 706A. RF circuitry 706 can also include synthesizer circuitry 706D for synthesizing a frequency for use by mixer circuitry 706A of the receive signal path and the transmit signal path. In some implementations, mixer circuitry 706A of the receive signal path can be configured to down-convert RF signals received from FEM circuitry 708 based on the synthesized frequency provided by synthesizer circuitry 706D. Amplifier circuitry 706B can be configured to amplify the down-converted signals and filter circuitry 706C can be a low-pass filter (LPF) or band-pass filter (BPF) configured to remove unwanted signals from the down-converted signals to generate output baseband signals. Output baseband signals can be provided to baseband circuitry 704 for further processing. In some implementations, the output baseband signals can be zero-frequency baseband signals, although this may not be a requirement. In some implementations, mixer circuitry 706A of the receive signal path can comprise passive mixers, although the scope of the implementations is not limited in this respect.

In some implementations, mixer circuitry 706A of the transmit signal path can be configured to up-convert input baseband signals based on the synthesized frequency provided by synthesizer circuitry 706D to generate RF output signals for FEM circuitry 708. The baseband signals can be provided by baseband circuitry 704 and can be filtered by filter circuitry 706C. In some implementations, mixer circuitry 706A of the receive signal path and mixer circuitry 706A of the transmit signal path can include two or more mixers and can be arranged for quadrature down conversion and up conversion, respectively. In some implementations, mixer circuitry 706A of the receive signal path and mixer circuitry 706A of the transmit signal path can include two or more mixers and can be arranged for image rejection. In some implementations, mixer circuitry 706A of the receive signal path and mixer circuitry 706A can be arranged for direct down conversion and direct up conversion, respectively. In some implementations, mixer circuitry 706 of the receive signal path and mixer circuitry 706A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 706 can include analog-to-digital converter (ADC) and digital-to-analog converter (DAC) circuitry and baseband circuitry 704 can include a digital baseband interface to communicate with RF circuitry 706.

In some dual-mode implementations, a separate radio integrated circuitry can be provided for processing signals for each spectrum, although the scope of the implementations is not limited in this respect. In some implementations, synthesizer circuitry 706D can be a fractional-N synthesizer or a fractional N/N+1 synthesizer, although the scope of the implementations is not limited in this respect as other types of frequency synthesizers can be suitable. For example, synthesizer circuitry 706D can be a delta-sigma synthesizer, a frequency multiplier, or a synthesizer comprising a phase-locked loop with a frequency divider.

Synthesizer circuitry 706D can be configured to synthesize an output frequency for use by mixer circuitry 706A of RF circuitry 706 based on a frequency input and a divider control input. In some implementations, synthesizer circuitry 706D can be a fractional N/N+1 synthesizer. In some implementations, frequency input can be provided by a voltage-controlled oscillator (VCO). Divider control input can be provided by either baseband circuitry 704 or the applications circuitry 702 depending on the desired output frequency. In some implementations, a divider control input (e.g., N) can be determined from a look-up table based on a channel indicated by the applications circuitry 702.

Synthesizer circuitry 706D of RF circuitry 706 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 706D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 706 can include an in-phase/quadrature (I/Q)/polar converter.

FEM circuitry 708 can include a receive signal path which can include circuitry configured to operate on RF signals received from one or more antennas 710, amplify the received signals and provide the amplified versions of the received signals to RF circuitry 706 for further processing. FEM circuitry 708 can also include a transmit signal path which can include circuitry configured to amplify signals for transmission provided by RF circuitry 706 for transmission by one or more of the one or more antennas 710. In various implementations, the amplification through the transmit or receive signal paths can be done solely in RF circuitry 706, solely in FEM circuitry 708, or in both RF circuitry 706 and FEM circuitry 708.

In some implementations, FEM circuitry 708 can include a transmit/receive switch to switch between transmit mode and receive mode operation. FEM circuitry 708 can include a receive signal path and a transmit signal path. The receive signal path of FEM circuitry 708 can include a low noise amplifier to amplify received RF signals and provide the amplified received RF signals as an output (e.g., to RF circuitry 706). The transmit signal path of FEM circuitry 708 can include a power amplifier to amplify input RF signals (e.g., provided by RF circuitry 706), and one or more filters to generate RF signals for subsequent transmission (e.g., by one or more of one or more antennas 710).

In some implementations, PMC 712 can manage power provided to baseband circuitry 704. In particular, PMC 712 can control power-source selection, voltage scaling, battery charging, or direct current (DC) to DC (DC-to-DC) conversion. PMC 712 can often be included when device 700 is capable of being powered by a battery, for example, when device 700 is included in a UE. PMC 712 can increase the power conversion efficiency while providing desirable implementation size and heat dissipation characteristics.

While FIG. 7 shows PMC 712 coupled only with baseband circuitry 704. However, in other implementations, PMC 712 can be additionally or alternatively coupled with, and perform similar power management operations for, other components such as, but not limited to, application circuitry 702, RF circuitry 706, or FEM circuitry 708.

In some implementations, PMC 712 can control, or otherwise be part of, various power saving mechanisms of device 700. For example, if device 700 is in an RRC_Connected state, where device 700 is still connected to the RAN node as device 700 expects to receive traffic shortly, then device 700 can enter a state known as discontinuous reception mode (DRX) after a period of inactivity. During this state, device 700 can power down for brief intervals of time and thus save power.

If there is no data traffic activity for an extended period of time, then device 700 can transition off to an RRC_Idle state, where device 700 disconnects from the network and does not perform operations such as channel quality feedback, handover, etc. Device 700 can go into a very low power state and device 700 can perform paging where again device 700 periodically can wake up to listen to the network and then power down again. Device 700 may not receive data in this state; in order to receive data, device 700 can transition back to RRC_Connected state.

An additional power saving mode can allow a device to be unavailable to the network for periods longer than a paging interval (ranging from seconds to a few hours). During this time, the device 700 can be unreachable to the network and can power down completely. Any data sent during this time can incur a large delay and device 700 can assume the delay is acceptable.

Processors of application circuitry 702 and processors of baseband circuitry 704 can be used to execute elements of one or more instances of a protocol stack. For example, processors of baseband circuitry 704, alone or in combination, can be used execute Layer 3, Layer 2, or Layer 1 functionality, while processors of baseband circuitry 704 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

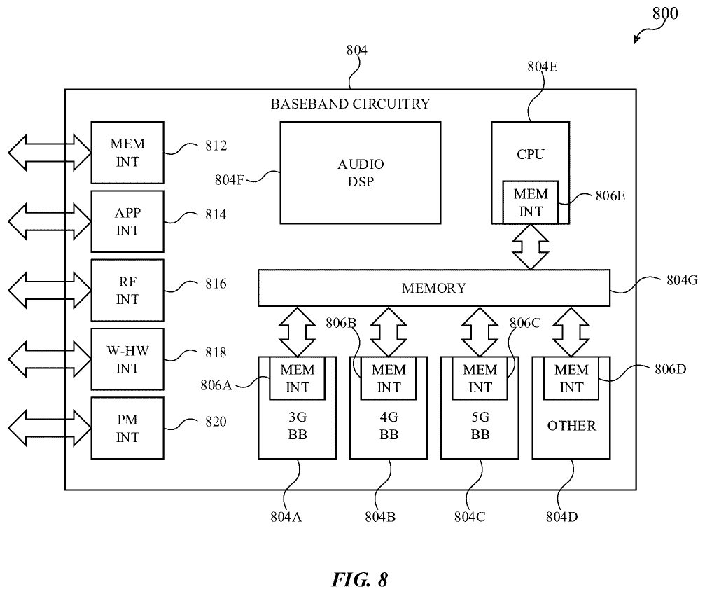

FIG. 8 is a diagram of example interfaces 800 of baseband circuitry according to one or more implementations described herein. One or more components or features of example interfaces 800 can correspond to one or more components or features described above or elsewhere. Baseband circuitry 804 can comprise processors 804A, 804B, 804C, 804D, and 804E and a memory 804G utilized by said processors. Each of processors 804A, 804B, 804C, 804D, and 804E can include a memory interface, 806A, 806B, 806C, 806D, and 806E, respectively, to send/receive data to/from memory 804G. Baseband circuitry can be a component of a UE and/or another type of device or system capable of transmitting and/or receiving wireless signals.

Baseband circuitry 804 can further include one or more interfaces to communicatively couple to other circuitries/devices, such as memory interface 812 (e.g., an interface to send/receive data to/from memory external to baseband circuitry 804), an application circuitry interface 814 (e.g., an interface to send/receive data to/from the application circuitry as described herein), an RF circuitry interface 816, a wireless hardware connectivity interface 818 (e.g., an interface to send/receive data to/from near field communication components, Bluetooth® components (e.g., Bluetooth® Low Energy), Wi-Fi® components, and other communication components), and a power management interface 820 (e.g., an interface to send/receive power or control signals to/from a PMC).

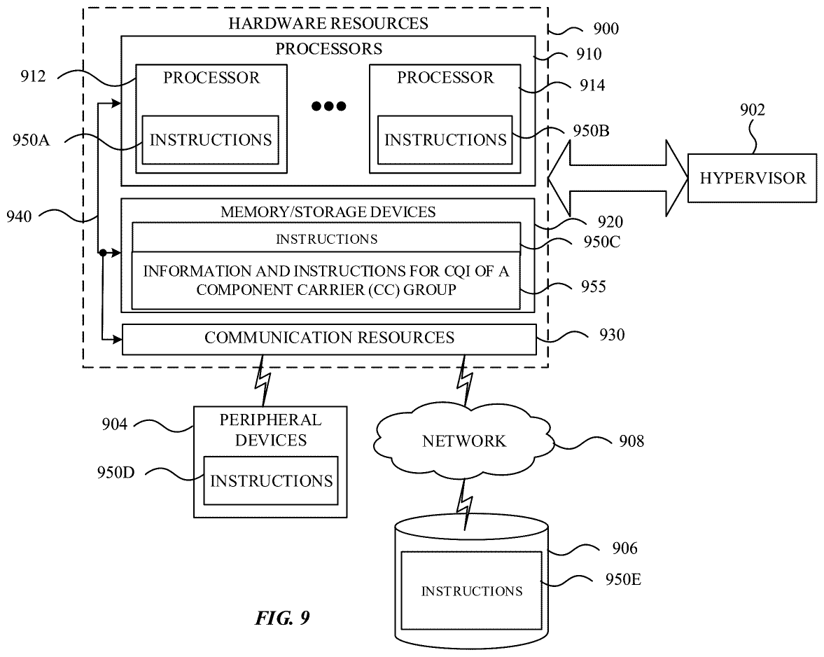

FIG. 9 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors 910 (or processor cores), one or more memory/storage devices 920, and one or more communication resources 930, each of which can be communicatively coupled via a bus 940. For implementations where node virtualization or network function virtualization is utilized, a hypervisor can be executed to provide an execution environment for one or more network slices/sub-slices to utilize hardware resources 900. Hardware resources 900 can interact with hypervisor 902. For example, hypervisor 902 can schedule or otherwise manage hardware resource 900.

Processors 910 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 912 and a processor 914.

Memory/storage devices 920 can include main memory, disk storage, or any suitable combination thereof. Memory/storage devices 920 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 920 receive and/or store information and instructions 955 for determining a channel quality indicator (CQI) associated with a group of CCs. UE 210 and base station 222 can establish a connection using CA that involves a group of CCs. Base station 222 can provide UE 210 with configuration information that enables UE 210 to measure a signal quality of different CCs, of the CC group, at different times. The measurement can be based on a reference signal from the base station, such as a CSI-RS. UE 210 can determine a CQI for one CC, of the CC group, and report the CQI to base station 222. Base station 222 can use the CQI to determine a CQI for another CC of the CC group and/or a CQI for the entire CC group. Many other aspects and examples are also described herein.

Communication resources 930 can include interconnection or network interface components or other suitable devices to communicate with one or more peripheral devices 904 or one or more databases 906 via a network 908. For example, communication resources 930 can include wired communication components (e.g., for coupling via a universal serial bus), cellular communication components, near field communication components, Bluetooth® components (e.g., Bluetooth® Low Energy), Wi-Fi® components, and other communication components.

Instructions 950A, 950B, 950C, 950D, and/or 950E can comprise software, a program, an application, an applet, an app, or other executable code for causing at least any of processors 910 to perform any one or more of the methodologies discussed herein. Instructions 950 can reside, completely or partially, within at least one of processors 910 (e.g., within a cache memory), memory/storage devices 920, or any suitable combination thereof. Furthermore, any portion of instructions 950A-E can be transferred to hardware resources 900 from any combination of peripheral devices 904 or databases 906. Accordingly, memory of processors 910, memory/storage devices 920, peripheral devices 904, and databases 906 are examples of computer-readable and machine-readable media.

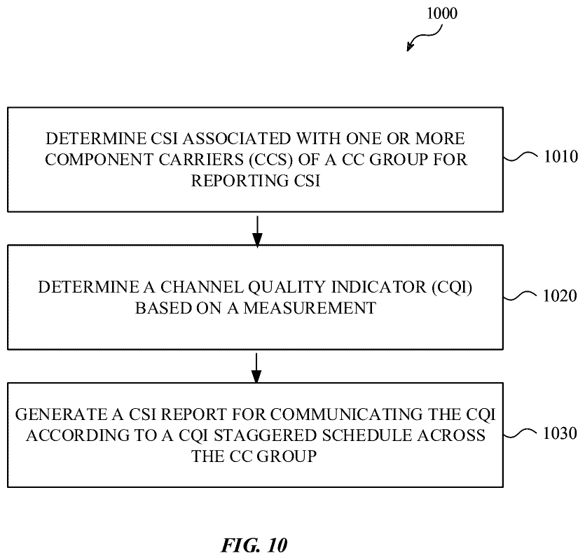

FIG. 10 is a diagram of an example process 1000 for CQI duty cycling across component carriers according to one or more implementations described herein. As shown, process 1000 can be implemented by UE 110 and/or baseband circuitry 1104. In some implementations, some or all of process 1000 can be performed by one or more other systems or devices, including one or more of the devices of FIG. 2. Additionally, process 1000 can include one or more fewer, additional, differently ordered and/or arranged operations than those shown in FIG. 10. In some implementations, some or all of the operations of process 1000 can be performed independently, successively, simultaneously, etc., of one or more of the other operations of process 1000. As such, the techniques described herein are not limited to the number, sequence, arrangement, timing, etc., of the operations or processes depicted in FIG. 10.

As shown, process 1000 can include determining channel state information (CSI) associated with one or more component carriers (CCs) of a CC group for reporting CSI (block 1010). Process 1000 can include determining a channel quality indicator (CQI) based on a measurement (block 1020). Process 1000 can include generating a CSI report for communicating the CQI according to a CQI staggered schedule across the CC group (block 1030). The CSI report can be for the CCs. One or more of the examples described herein can also, or alternatively, be part of process 1000.

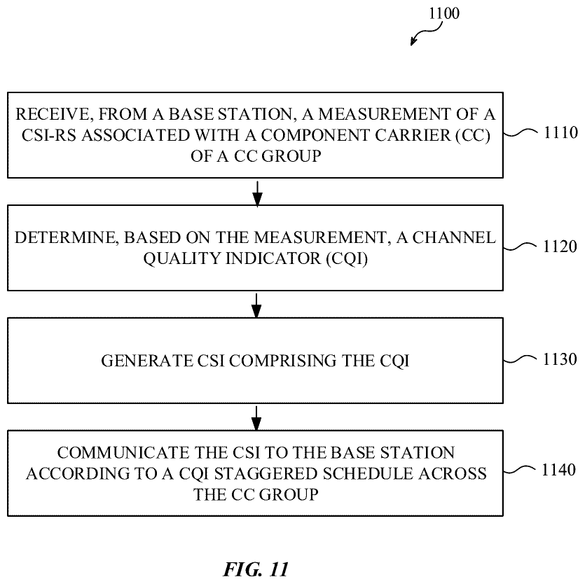

FIG. 11 is a diagram of an example process 1100 for CQI duty cycling across component carriers according to one or more implementations described herein. As shown, process 1100 can be implemented by UE 110 and/or baseband circuitry 1104. In some implementations, some or all of process 1100 can be performed by one or more other systems or devices, including one or more of the devices of FIG. 2. Additionally, process 1100 can include one or more fewer, additional, differently ordered and/or arranged operations than those shown in FIG. 11. In some implementations, some or all of the operations of process 1100 can be performed independently, successively, simultaneously, etc., of one or more of the other operations of process 1100. As such, the techniques described herein are not limited to the number, sequence, arrangement, timing, etc., of the operations or processes depicted in FIG. 11.

As shown, process 1100 can include receiving, from a base station, a measurement of a channel state information (CSI) reference signal (RS) (CSI-RS) associated with a component carrier (CC) of a CC group (block 1110). Process 1100 can include determining, based on the measurement, a channel quality indicator (CQI) (block 1120). Process 1100 can include generating CSI comprising the CQI (block 1130). Process 1100 can include communicating the CSI to the base station according to a CQI staggered schedule across the CC group (block 1140). One or more of the examples described herein can also, or alternatively, be part of process 1100.

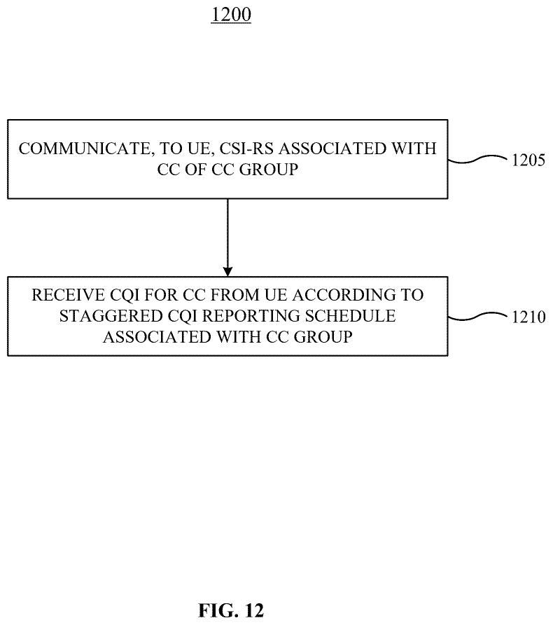

FIG. 12 is a diagram of an example process 1200 for CQI duty cycling across component carriers according to one or more implementations described herein. As shown, process 1200 can be implemented by base station 122 and/or baseband circuitry 1204. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to the number, sequence, arrangement, timing, etc., of the operations or processes depicted in FIG. 12.

As shown, process 1200 can include communicating, to a user equipment (UE), a channel state information (CSI) reference signal (RS) (CSI-RS) associated with a component carrier (CC) of a CC group (block 1205). Process 1200 can include receiving a CQI for the CC from the UE according to a staggered CQI reporting schedule associated with the CC group (block 1210). One or more of the examples described herein can also, or alternatively, be part of process 1200.

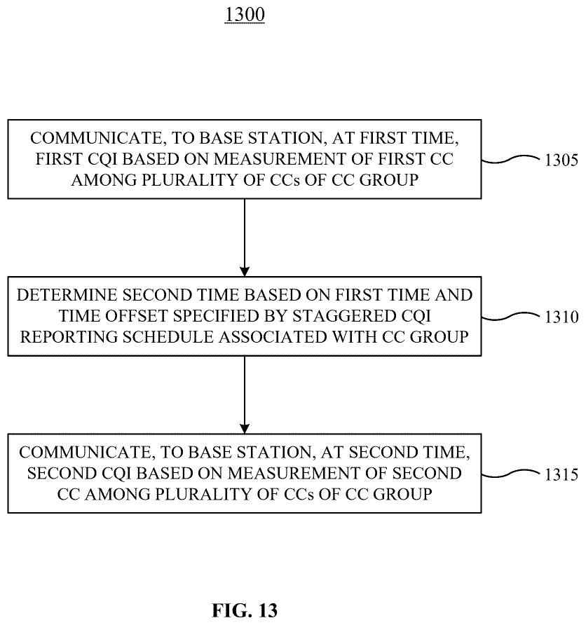

FIG. 13 is a diagram of an example process 1300 for CQI duty cycling across component carriers according to one or more implementations described herein. As shown, process 1300 can be implemented by UE 110 and/or baseband circuitry 1104. In some implementations, some or all of process 1300 can be performed by one or more other systems or devices, including one or more of the devices of FIG. 2. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to the number, sequence, arrangement, timing, etc., of the operations or processes depicted in FIG. 13.

As shown, process 1300 can include communicating, to a base station, at a first time, a first CQI based on a measurement of a first CC among a plurality of CCs of a CC group (block 1305). Process 1300 can include determining a second time based on the first time and a time offset specified by a staggered CQI reporting schedule associated with the CC group (block 1310). Process 1300 can include communicating, to the base station, at a second time, a second CQI based on a measurement of a second CC among the plurality of CCs of the CC group (block 1315). One or more of the examples described herein can also, or alternatively, be part of process 1300.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, baseband circuitry can comprise one or more processors configured to: determine channel state information (CSI) associated with one or more component carriers (CCs) of a CC group for reporting CSI; determine a channel quality indicator (CQI) based on a measurement; and generate a CSI report for communicating the CQI according to a CQI staggered schedule across the CC group, wherein the CSI report is for the CCs.

In example 2, which can also include one or more of the examples described herein, the measurement comprises a signal strength of a CSI reference signal (RS) (CSI-RS).

In example 3, which can also include one or more of the examples described herein, the CSI-RS is transmitted in accordance with a CSI-RS duty cycle comprising CSI-RS transmissions across the CC group according to a CSI-RS staggering schedule.

In example 4, which can also include one or more of the examples described herein, the CSI-RS is transmitted in accordance with a CQI duty cycle comprising the CQI staggered schedule.

In example 5, which can also include one or more of the examples described herein, the CQI is configured to be used to determine a CQI for at least one other CC of the CC group.

In example 6, which can also include one or more of the examples described herein, the CQI is configured to be used to determine a CQI for the CC group.

In example 7, which can also include one or more of the examples described herein, a rank of the CQI is configured to be used to determine a CQI for at least one other CC of the CC group.

In example 8, which can also include one or more of the examples described herein, the CQI is configured to be used to determine a CQI for at least one other CC of the CC group based on the rank and a signal-to-interference-plus-noise ratio (SINR).

In example 9, which can also include one or more of the examples described herein, the CQI is configured to be used to determine a CQI for at least one other CC of the CC group when a precoding matrix indicator (PMI) between CCs match one another.

In example 10, which can also include one or more of the examples described herein, the CQI is configured to be used to determine a CQI for at least one other CC of the CC group based on a filter applied to the CQI.

In example 11, which can also include one or more of the examples described herein, the CC group and the CQI staggered schedule is indicated via configuration information comprising at least one of: a CC-GroupForCQI information element (IE), a CC-GroupForCSI IE, or a combination thereof.

In example 12, which can also include one or more of the examples described herein, baseband circuitry can comprise one or more processors configured to: obtain a measurement of a channel state information (CSI) reference signal (RS) (CSI-RS) associated with a component carrier (CC) of a CC group for the for the CSI-RS; determine, based on the measurement, a channel quality indicator (CQI); and generate CSI for communicating the CQI according to a CQI staggered schedule across the CC group.

In example 13, which can also include one or more of the examples described herein, the one or more processors are configured to: receive an indication of the CC group for the CSI-RS from a base station, wherein the CC group comprises CCs associated with a plurality of cells.

In example 14, which can also include one or more of the examples described herein, the indication of the CC group for the CSI-RS is determined as part of a carrier aggregation (CA) procedure.

In example 15, which can also include one or more of the examples described herein, the one or more processors are configured to: determine a preferred CC for reporting the CQI; and generate an indication of the preferred CC, wherein: the CC group comprises the preferred CC, and the CQI is communicated via the preferred CC.

In example 16, which can also include one or more of the examples described herein, the measurement comprises a signal strength of the CSI-RS.

In example 17, which can also include one or more of the examples described herein, the CSI-RS is transmitted in accordance with a CSI-RS duty cycle comprising CSI-RS transmissions across the CC group according to a CSI-RS staggering schedule.

In example 18, which can also include one or more of the examples described herein, the CSI-RS is transmitted in accordance with a CQI duty cycle comprising the CQI staggered schedule.

In example 19, which can also include one or more of the examples described herein, the CQI is configured to be used to determine a CQI for at least one other CC of the CC group.

In example 20, which can also include one or more of the examples described herein, the CQI is configured to be used to determine a CQI for the CC group.

In example 21, which can also include one or more of the examples described herein, a rank of the CQI is configured to be used to determine a CQI for at least one other CC of the CC group.

In example 22, which can also include one or more of the examples described herein, the CQI is configured to be used to determine a CQI for at least one other CC of the CC group based on the rank and a signal-to-interference-plus-noise ratio (SINR).

In example 23, which can also include one or more of the examples described herein, the CQI is configured to be used to determine a CQI for at least one other CC of the CC group when a precoding matrix indicator (PMI) between CCs match one another.

In example 24, which can also include one or more of the examples described herein, the CQI is configured to be used to determine a CQI for at least one other CC of the CC group based on a filter being applied to the CQI.

In example 25, which can also include one or more of the examples described herein, the CC group and the CQI staggered schedule is indicated via configuration information.

In example 26, which can also include one or more of the examples described herein, the configuration information comprises a CC-GroupForCSI information element (IE).

In example 27, which can also include one or more of the examples described herein, a user equipment (UE) can comprise: a memory comprising one or more instructions; and one or more processors configured to execute the one or more instructions to: receive, from a base station, a measurement of a channel state information (CSI) reference signal (RS) (CSI-RS) associated with a component carrier (CC) of a CC group; determine, based on the measurement, a channel quality indicator (CQI); generate CSI comprising the CQI; and communicate the CSI to the base station according to a CQI staggered schedule across the CC group.

In example 28, which can also include one or more of the examples described herein, the one or more processors are configured to: receive an indication of the CC group, wherein the CC group comprises CCs associated with a plurality of cells.

In example 29, which can also include one or more of the examples described herein, the one or more processors are configured to: determine a preferred CC for reporting the CQI; and generate an indication of the preferred CC, wherein: the CC group comprises the preferred CC, and the CQI is communicated via the preferred CC.

In example 30, which can also include one or more of the examples described herein, a base station can comprise a memory comprising one or more instructions; and one or more processors configured to execute the one or more instructions to: communicate, to a user equipment (UE), a channel state information (CSI) reference signal (RS) (CSI-RS) associated with a component carrier (CC) of a CC group; and receive, from the UE, CSI comprising according to a CQI staggered schedule across the CC group.

In example 31, which can also include one or more of the examples described herein, the one or more processors are configured to: communicate an indication of the CC group, wherein the CC group comprises CCs associated with a plurality of cells.

In example 32, which can also include one or more of the examples described herein, the indication of the CC group is determined as part of a carrier aggregation (CA) procedure.

In example 33, which can also include one or more of the examples described herein, the one or more processors are configured to: receive, from the UE, an indication of a preferred CC, wherein: the CC group comprises the preferred CC, and the CQI is communicated via the preferred CC.

In example 34, which can also include one or more of the examples described herein, the CSI-RS is transmitted in accordance with a CSI-RS duty cycle comprising CSI-RS transmissions across the CC group according to a CSI-RS staggering schedule.

In example 35, which can also include one or more of the examples described herein, the CSI-RS is transmitted in accordance with a CQI duty cycle comprising the CQI staggered schedule.

In example 36, which can also include one or more of the examples described herein, the one or more processors are configured to: determine a CQI for at least one other CC of the CC group.

In example 37, which can also include one or more of the examples described herein, the one or more processors are configured to: determine a CQI for the CC group.

In example 38, which can also include one or more of the examples described herein, the one or more processors are configured to: determine a CQI for at least one other CC of the CC group based on a rank of the CQI from the UE.

In example 39, which can also include one or more of the examples described herein, the one or more processors are configured to: determine a CQI for at least one other CC of the CC group based on the rank of the CQI and a signal-to-interference-plus-noise ratio (SINR).

In example 40, which can also include one or more of the examples described herein, the one or more processors are configured to: determine a CQI for at least one other CC of the CC group when a precoding matrix indicator (PMI) between CCs match one another.

In example 41, which can also include one or more of the examples described herein, the one or more processors are configured to: determine a CQI for at least one other CC of the CC group based on a filter being applied to the CQI.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. Baseband circuitry, comprising:
one or more processors configured to:
communicate, to a base station, at a first time, a first channel quality indicator (CQI) based on a measurement of a first component carrier (CC) among a plurality of CCs of a CC group;
determine a second time based on:
the first time; and
a time offset specified by a staggered CQI reporting schedule associated with the CC group; and
communicate, to the base station, at the second time, a second CQI based on a measurement of a second CC among the plurality of CCs of the CC group.

2. The baseband circuitry of claim 1, wherein the measurement of the first CC comprises a signal strength of a first CSI reference signal (RS) (CSI-RS) on the first CC and the measurement of the second CC comprises a signal strength of a second CSI-RS on the second CC.

3. The baseband circuitry of claim 2, the one or more processors configured to determine an offset between respective times of transmission of the first and second CSI-RSs based on a staggered CSI-RS transmission schedule.

4. The baseband circuitry of claim 3, the one or more processors configured to determine the staggered CSI-RS transmission schedule based on the staggered CQI reporting schedule.

5. The baseband circuitry of claim 3, the one or more processors configured to determine the staggered CQI reporting schedule based on the staggered CSI-RS transmission schedule.

6. The baseband circuitry of claim 2, wherein an offset between respective times of transmission of the first and second CSI-RSs matches the time offset specified by the staggered CQI reporting schedule.

7. The baseband circuitry of claim 1, the one or more processors configured to determine the CC group and the CQI staggered schedule based on configuration information comprising at least one of:
a CC-GroupForCQI information element (IE),
a CC-GroupForCSI IE, or
a combination thereof.

8. Baseband circuitry, comprising:
one or more processors configured to:
obtain a measurement of a channel state information (CSI) reference signal (RS) (CSI-RS) associated with a component carrier (CC) of a CC group for the CSI-RS;
determine, based on the measurement, a channel quality indicator (CQI); and
generate CSI for communicating the CQI according to a CQI staggered schedule across the CC group.

9. The baseband circuitry of claim 8, wherein the one or more processors are configured to: receive an indication of the CC group for the CSI-RS from a base station, wherein the CC group comprises CCs associated with a plurality of cells.

10. The baseband circuitry of claim 9, wherein the indication of the CC group for the CSI-RS is determined as part of a carrier aggregation (CA) procedure.

11. The baseband circuitry of claim 8, wherein the one or more processors are configured to:
determine a preferred CC for reporting the CQI; and
generate an indication of the preferred CC, wherein:
the CC group comprises the preferred CC, and
the CQI is communicated via the preferred CC.

12. The baseband circuitry of claim 8, wherein the measurement comprises a signal strength of the CSI-RS.

13. The baseband circuitry of claim 8, wherein the CSI-RS is transmitted in accordance with a CSI-RS duty cycle comprising CSI-RS transmissions across the CC group according to a CSI-RS staggering schedule.

14. The baseband circuitry of claim 8, wherein the CSI-RS is transmitted in accordance with a CQI duty cycle comprising the CQI staggered schedule.

15. A base station, comprising:
a memory comprising one or more instructions; and
one or more processors configured to execute the one or more instructions to:
communicate, to a user equipment (UE), a channel state information (CSI) reference signal (RS) (CSI-RS) associated with a component carrier (CC) of a CC group; and
receive a channel quality indicator (CQI) for the CC from the UE according to a staggered CQI reporting schedule associated with the CC group.

16. The base station of claim 15, the one or more processors configured to:
communicate an indication of the CC group to the UE, wherein the CC group comprises CCs associated with a plurality of cells.

17. The base station of claim 15, the one or more processors configured to use the CQI to determine a CQI for at least one other CC of the CC group.

18. The base station of claim 15, the one or more processors configured to use the CQI to determine a CQI for the CC group.

19. The base station of claim 15, the one or more processors configured to use a rank of the CQI to determine a CQI for at least one other CC of the CC group.

20. The base station of claim 19, the one or more processors configured to determine the CQI for the at least one other CC of the CC group based on the rank and on a signal-to-interference-plus-noise ratio (SINR).
